(19) United States
(12) Patent Application Publication
(10) Pub. No.: US 2003/0101156 A1
(43) Pub. Date: May 29, 2003

(54) Database systems and methods

(76) Inventor: Kenneth R. Newman, Willis, TX (US)

Correspondence Address: Guy McClung, PMB 347, 16690 Champion Forest Drive, Spring, TX, 77379-7023, US

(21) Appl. No.: 09/992,098

(22) Filed: Nov. 26, 2001

(51) Int. Cl. G06F 7/00

(52) U.S. Cl. 707/1

(57) ABSTRACT

A system for acquiring information associated with an industrial operation, the system including in at least certain aspects first generating apparatus for generating first data representative of at least one parameter of an industrial operation (including, but not limited to oilfield operations), the first data generatable in digitized form, second generating apparatus for generating second data related to at least one image of an actual physical aspect of the industrial operation, the second data generatable in digitized form, storage apparatus for storing the first data and the second data, and accessing apparatus for simlutaneously accessing the first data and the second data, the second data in certain aspects accessible as sensible audio and/or visual images.

### BACKGROUND OF THE INVENTION

1. Field of the Invention

This invention is directed to databases of information, systems that use such databases, and, in certain particular aspects, to such databases and methods of their use that incorporate into a database both first data representative of a parameter or measured aspect of a process, method, task, or operation or step thereof and second data representative of an audio, pictorial, and/or video (“APV”) image of the process, etc., and provide for accessing of and the display and/or playback of both first and second data, in one aspect, simultaneously.

2. Description of Related Art

There are a wide variety of prior art systems employed in industry which involve the aquisition of data regarding the industry's methods, processes, and operations. Many parameters of or associated with the methods, tasks, results, apparatuses, and operations, and processes have been monitored, tested, recorded and/or measured in some way to produce digitized information about the method, task or operation. In the past sensible images of such methods, etc. have been photographed and videographed; and sound recordings have been made of comments on them. For example, (but not by way of limitation) electronic data acquisition systems with associated sensors and/or meters are common in many industries. These systems acquire one or more channels of data from a variety of sources, meters, devices, and sensors and store the data in databases. The data can be selectively reviewed and/or played back.

There are a wide variety of prior art systems employed in the oilfield industries which involve the aquisition of data regarding “oil patch” operations. Many methods, tasks, results, apparatuses, and operations have been monitored, tested, or measured in some way to produce digitized information about the method, task or operation. For example, (but not by way of limitation) electronic data acquisition systems are common in oilfield drilling and well service operations. These systems acquire channels of data from a variety of sensors and store the data in databases. U.S. Pat. No. 6,152,246—incorporated fully herein for all purposes—is one example of patents that address these systems.

In a simple prior art system as shown in FIG. 1, a data acquisition device 101 acquires data from sensors 100. These sensors may be any known sensor sued in the prior art, including, but not limited to, pressure transducers, depth wheels, flow meters, temperature sensors, etc. These sensors may be located at the surface, on or above a rig floor, and/or downhole in a well. The data acquisition device 101 usually acquires data from these sensors at a regular time interval, e.g., every 0.1 1.0, or 0.01 seconds into a stream of data known as a “channel”. This data is stored in a data storage device 102 and may be displayed by a data display device 103. It may also be used to produce and send alarms. In some systems the data acquisition device 101, the data storage device 102 and the data display device 103 are all incorporated in one device, apparatus, or system.

FIG. 2 shows a more complex prior art data acquisition system. This system has a plurality of data acquisition devices 201 and 203 that acquire data from a plurality of sets of sensors 200 and 202. There may be multiple storage devices 204 and 205, a single or multiple server(s) 208, and multiple display devices 206 and 207. These devices may be connected directly to each other (not shown) or they may be connected via a network 210. Some elements of this system may be combined. For example, in some systems the server(s) also store the data. The connections between devices may be through a wire or by wireless communication including radio transmission, microwave transmission and even satellite transmission. In some systems part of the network 210 is the Internet.

The channels of data stored by these prior art systems typically store one value at one specific point in time for a given channel. It is typical for these channels of data to be graphed (on the display device and/or on paper) versus time or versus the depth of the current operation. These graphs are typically known as “logs”. Logs typically display a plurality of channels on a single graph so that changes in these channels can be compared versus time or depth.

There has long been a need, recognized by the present inventor, to integrate digital audio, photo and/or video (“APV”) information into known database systems that inlcude data related to industrial operations, methods, etc. There has long been a need, recognized by the present inventor, for a system in which users of the system can store and retrieve spoken messages (audio) and/or pictures taken with a digital camera (photo) and/or video taken with a digital video camera. There has long been a need for such a system in which other users of the system can access this APV information. There has long been a need, recognized by the present inventor, for a system that can be accessed to present both system-parameter data and sytem-image data that relates to the system-parameter data, in one aspect, simultaneously.

### SUMMARY OF THE PRESENT INVENTION

The present invention provides, in at least certain embodiments, a method for storing, retrieving, and using APV information related to recorded images of steps in or parts of an industrial operation (e.g., but not limited to, an oilpatch operation) which includes sensing and/or measuring an operation parameter and/or, metering with respect to some step or aspect of the operation; and, in particular aspects, such a method in oilfield drilling or servicing operations that use data acquisition systems.

The present invention provides, in at least certain embodiments, a system and method for acquiring information associated with an industrial operation (including, but not limited to, oilfield operations), the system including in at least certain aspects first generating apparatus for generating first data representative of at least one parameter or aspect of an industrial operation (including, but not limited to oilfield operations, e.g., drillling), the first data generatable in digitized form, second generating apparatus for generating second data related to at least one image of an actual physical step or aspect of the industrial operation, the second data generatable in digitized form, storage apparatus for storing the first data and the second data, and, optionally, presentation apparatus (including, but not limited to viewing screen apparatus and/or audio playback apparatus) for presenting the first data and the second data (in one aspect simultaneously), the second data in certain aspects presentable as sensible (able to be heard and/or seen) audio and/or visual images.

In one embodiment of the present invention, audio messages are made and stored in a system data acquisition device or apparatus and then combined with other digitized data (e.g., but not limited to, test data, measurement data, sensor-generated data, meter-generated data) related to an industrial operation, etc., e.g., but not limited to, an oilpatch operation, process, task, or method. Both types of data can then be presented, replayed, and/or displayed—in one aspect, simultaneously. For example, and not by way of limitation, in an oilfield drilling operation, weight on bit is monitored and data representative of the weight on a bit is measured and recorded with apparatus used for such measurement and recording, while, at the same time, an audio recording is being made by a rig hand, an engineer, a driller, or other personnel describing what is occurring downhole and/or on or in the rig at that time. During a display of the weight-on-bit data (e.g. on a screen or computer monitor) the audio recording is also played by any suitable apparatus so that a person reviewing the weight-on-bit data hears the recording about what was happening at that time.

In certain aspects according to the present a microphone is used for producing audio messages that are then directed to a data acquisition device. A single device may incorporate both a microphone and a data acquisition/storage device. For example, according to the present invention a microphone and a data acquisition apparatus are combined in an apparatus that resembles a walkie-talkie or a personal data assistant or palm-held computer device, e.g., but not limited to, a device like a Compaq IPAQ PDA (personal data assistant) or a notebook computer. The user initiates a message by pushing and holding a button or turning a knob on the device, while speaking into the device's microphone. Upon release of the button or turning of the knob, the data acquisition device transmits a digital audio file of the message to a server or servers or other staorage apparatus. Alternatively, a device is activated which provides a signal after which a voice recording is initiated, and then, at the end of the recording, the user deactivates the device. Such activation and deactivation may be effected by a spoken password, by the click of a computer mouse, or by any suitable known activation/deactivation apparatus. Alternatively, or in addition to this procedure, a message may be stored in the data acquisition device until some later time when the device is connected to a network or data storage device, at which point the digital audio file(s) are transferred or downloaded.

In certain embodiments of the present invention, digitized photographs and/or digitized video are produced by a digital camera or video camera and data related to thus-produced images is provided to a data acquisition device; or, as described above, the camera and data acquisition device are an integral unit. When a photo or video is taken, it is transmitted to a server or other storage apparatus. Alternatively, as with an audio file, a digital photo or video file may be accessed and/or downloaded at a later time. In certain particular aspects digital cameras with a microphone are used and this allows an audio message to be acquired at the same time as a photo or video.

Devices useful in methods and systems according to the present invention may be hand-held, wireless devices that allow a user to move around; e.g, for users like a test technician, and equipment monitoring technician, mud logger, tool pusher, or a company man; or they may be fixed devices at specific stations such as at a monitoring technician's or driller's console. Also, fixed cameras and fixed audio recorders may be used; e.g, but not limited to, a digital camera or digital video camera fixed on or near an industrial system or drilling rig (optionally, with some range of movement) and focused on an area of interest.

In certain aspects of systems and methods according to the present invention, when APV files are transmitted from a data acquisition device to a data storage device, other information may also be transmitted that identifies the originating device, a person who created the APV files, and/or the time that they were created. These data files may be incorporated into a full database and/or they may be maintained separately. Separately stored files may contain pointers connecting or associating the APV files with other digital data.

In certain aspects of systems and methods according to the present invention, once APV files reach a data storage device, they are made available to users of the system through one or more display devices which display photos and/or “play” audio, and/or video files. An additional channel may be added to logs with indicators and/or icons indicating that such APV files are available. With computerized systems according to the present invention, a user can click on such an icon with a computer mouse or other computer apparatus and the APV file is displayed on a computer screen or other interconnected screen apparatus, with or without related parameter data. Alternatively, a user can request a list of all the APV files for a given time, e.g., in one particular aspect, in a drilling opeation for a depth range, and play one or more of these files selectively. In certain aspects voice recognition software is be used to convert audio files to text files. The text files may then be made available for use in reporting and/or they can be selectively displayed to a user. Optionally noise filters (physical apparatuses and/or computer programs) are used to enhance audio recordings.

It is, therefore, an object of at least certain preferred embodiments of the present invention to provide:

New, useful, unique, efficient, nonobvious systems and methods for incorporating audio, photo, and/or video information into databases that contain information about industrial operations, and, in certain aspects, to such systems which provide accessing of and/or display and/or playback of both types of data, in one aspect simultaneously;

New, useful, unique, efficient, nonobvious systems and methods for incorporating audio, photo, and/or video information into databases that contain information about oilfield operations;

Such systems and methods that employ a hand-held device to produce an audio, photo, and/or video message whose information can be digitized for inclusion in such a database;

Such systems and methods in which such audio, photo, and/or video information is retrieved and/or used at a time after its production and/or transmission to a storage device;

Such systems and methods in which such information is selectively retrieved and/or selectively displayed, and, in certain particular aspects, such systems in which an icon on a screen is selectable to play back on the screen selected APV data;

Such systems and methods which provide simultaneous display and/or playback of both types of data—system image data and system parameter data; and

Such systems and methods that employ voice recognition software to produce digitized versions of audio messages.

Certain embodiments of this invention are not limited to any particular individual feature disclosed here, but include combinations of them distinguished from the prior art in their structures and functions. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods that do not depart from the spirit and scope of the present invention.

The present invention recognizes and addresses the previously mentioned problems and long-felt needs and provides a solution to those problems and a satisfactory meeting of those needs in its various possible embodiments and equivalents thereof. To one skilled in this art who has the benefits of this invention's realizations, teachings, disclosures, and suggestions, other purposes and advantages will be appreciated from the following description of preferred embodiments, given for the purpose of disclosure, when taken in conjunction with the accompanying drawings. The detail in these descriptions is not intended to thwart this patent's object to claim this invention no matter how others may later disguise it by variations in form or additions of further improvements.

### BRIEF DESCRIPTION OF THE DRAWINGS

A more particular description of embodiments of the invention briefly summarized above may be had by references to the embodiments which are shown in the drawings which form a part of this specification. These drawings illustrate certain preferred embodiments and are not to be used to improperly limit the scope of the invention that may have other equally effective or legally equivalent embodiments.

FIGS. 1 and 2 present schematically prior art systems.

FIG. 3 is a schematic representation of a system according to the present invention.

FIG. 4 shows a log created with a system and method according to the present invention.

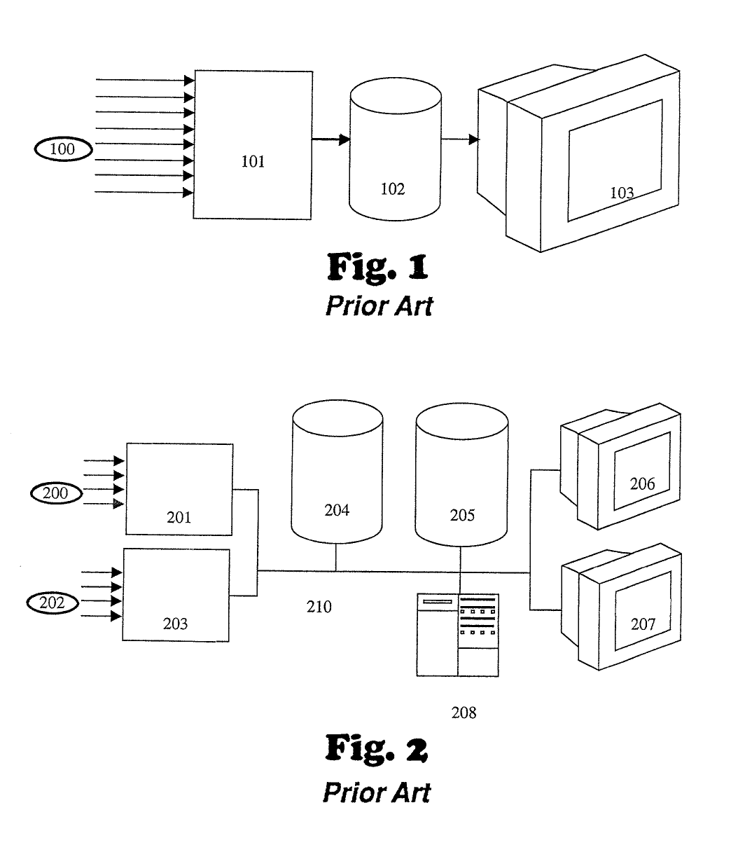

### DESCRIPTION OF EMBODIMENTS PREFERRED AT THE TIME OF FILING FOR THIS PATENT

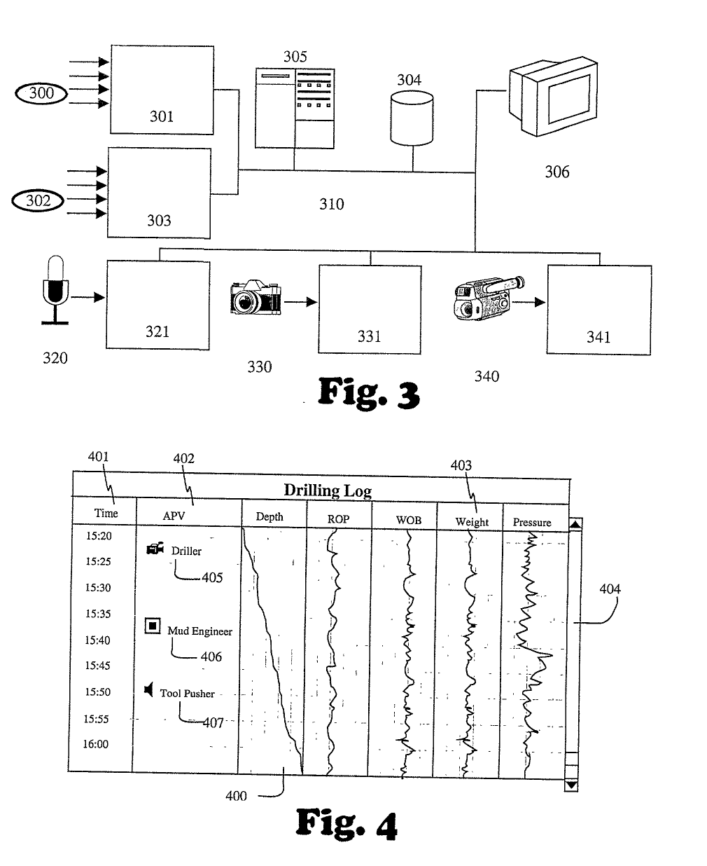

FIG. 3 shows a system 30 according to the present invention that includes data acquisition system with APV capabilities. The system 30 has a plurality of analog and/or digital output sensors 300 and 320 that may be any sensor known in the prior art for sensing and/or measuring a parameter related to any industrial operation, etc., including, but not limited to, an oilfiled operation, method, or task, and which, in certain particular aspects, measure such surface quantities as depth, speed, pump pressure, wellhead pressure, torque, turns, mud density, cement pressure, and/or hook load. Some of these sensors may be downhole sensors for measuring any parameter measured downhole in the prior art, including, but not limited to, measuring such quantities as weight on bit, inclination, azimuth, bottomhole pressure, temperature, and formation-resistivity. Audio, photo and/or video (APV) devices such as a microphone 320, digital camera 330, and/or digital video camera 340 can be used to capture audio, photo and/or video information, either above the surface or downhole. Any known fiber optic system and/or video system may, according to the present invention, be used to assist in obtaining photographs and/or video either downhole or at the surface. Such APV devices may be hand-held devices or they may be fixed at a specific location. Each APV device may be controlled by an “APV user” (such as, but not limited to, a tool pusher, a driller, a field engineer, a company man, or a mud man) who decides when to record an audio message, or to take a picture, or to take a video clip. Such APV devices according to the present invention may run continuously or may be run selectively at desired times or automatically for desired time periods.

The APV devices may each be associated with a single or multiple data acquisition devices 301, 303, 321, 331, and/or 341. In one apect the sensors 301 and 303 are read at a fixed time interval such as 1 second, though the time interval may vary significantly from 0.01 seconds to minutes or even hours. A data stream from a particular sensor 301 and/or 303 is also known as a “channel” of data. Calculations may be performed upon the data to create calculated channels. For example, speed is often calculated based up the rate of change of depth. Thus, speed is a calculated channel. The data acquisition device(s) 321, 331, and 341 from APV devices 320, 330 and/or 340 output digital files of APV information, “APV files”. Optionally, they also output “tag” information such as the identification of the user and/or APV device that created the information (spoke the audio message, took the photo or video), and/or the date and time it was created.

The channels of data may be filtered, removing excess and/or unwanted data, to reduce the amount of data that is to be stored. The channel data may be averaged over some time increment to remove abrupt spikes and/or anomalies in the data. The APV files may be compressed to reduce their size. This data processing may be done by the data acquisition devices 301, 303, 321, 331 and/or 341, or by the server(s) 305. The server(s) 305 may be part of the data acquisition device(s) 301, 303, 321, 331 and/or 341, or they may be a separate device.

The “data” which includes data channels, calculated channels, APV files and tags, are stored on the data storage device(s) 304 which may be part of the server(s) 305, or may be separate device(s). The data may be stored on one data storage device, or it may be stored multiple times on multiple data storage devices. One copy of the data may be stored “locally” (on site, near the well service or drilling operation), and/or may be stored “remotely” at a storage location sometimes known as a “data warehouse”. A network 310 may be used to transmit the data between the data acquisition devices 301, 303, 321, 331 and/or 341 and the server(s) 305 and the data storage device(s) 304. This network 310 may be one, two or more local area networks and/or one, two or more wide area networks and/or the Internet. It may use several methods of transferring information including, but not limited to, cable, fiber optic cable, telephone line, radio transmission, micro-wave transmission, satellite data transmission and the Internet. The network may also include the movement of data by some transportable media (e.g., CD ROM, floppy disk, flash disk, hard disk, smart card, etc.). The data is written to the transportable media by one device, and the media is transported to another device that reads the data from the media.

The network 310 also connects display devices 306 to the data, so that data users (anyone who needs to and is allowed to access the data) may review the data. For the data user to access the APV files, a display device 306 is able to display photos and play audio and video files. The data users may be local and/or remote to the operation. The data users may access the data while the operation is in progress, and/or after the operation is complete.

The data may be presented to the data user in the form of a “log” 400 as shown in FIG. 4 which may be a paper print out and/or a screen display. The log 400 may show any data related to any industrial operation, etc., including, but not limtied to, an oilfield operation. As shown in the particular embodiment of FIG. 4, which may, optionally, be displayed on a monitor or screen, several analog/digital channels 403 including depth, rate of penetration (ROP), weight on bit (WOB), and pressure, versus time 401 are illustrated. It also shows an APV channel 402. The APV channel 402 contains an indicator or, if the display is on a screen or monitor, an icon and the tag information for the specific APV file at the time the file was created; the icon 405 is an icon for a video file created by a driller at about 15:22 hours, the icon 406 is an icon for a photo file created a mud engineer at 15:36 hours, and the icon 407 is an icon for an audio file created by a tool pusher at 15:48 hours. In certain embodiments in which the log 400 is displayed on a screen or monitor, the data user can access the APV data by clicking on the desired icon with a computer mouse or similar apparatus. The data may also be presented and or displayed by any way known in the prior art, including, but not limited to, on-site and/or offsite on strip chart paper, by audio playback apparatus, by a cell phone, on the screen of a computer or televison, on the screen of a cell phone, or on the screen of a hand-held computerized device.

The present invention, therefore, in at least certain, if not all, embodiments, provides a system for acquiring information associated with an industrial operation, the system including first generating apparatus for generating first data representative of at least one parameter of an industrial operation, said first data generatable in digitized form, second generating apparatus for generating second data related to at least one image of an actual physical aspect of the industrial operation, said second data generatable in digitized form, storage apparatus for storing said first data and said second data, and presentation apparatus for simlutaneously presenting said first data and said second data.

The present invention, therefore, in at least certain, if not all, embodiments, provides a system for acquiring information associated with oilfield operations, the system including first generating apparatus for generating first data representative of at least one parameter of an oilfield operation, said first data generatable in digitized form, second generating apparatus for generating second data related to at least one image of an actual physical aspect of the oilfield operation, said second data generatable in digitized form, storage apparatus for storing said first data and said second data, and presentation apparatus for simlutaneously presenting said first data and said second data. Such a system may have one or some, in any possible combination, of the following: wherein said at least one image is from the group consisting of recorded audio images and recorded visual images of said actual physical aspect of said oilfield operation; wherein said second data relates to an audio image of said actual physical aspect of said oilfield operation recorded by sound recording apparatus; wherein said second data relates to a visual image of said actual physical aspect of said oilfield operation recorded by a photographic camera wherein said second data relates to visual images of said aspect of said oilfield operation recorded by video camera apparatus; wherein said first data and said second data are generated simultaneously, e.g, but not limited to, wherein data related to an operation is recorded and simulataneously an audio and/or visual image of the recording or of the state of or a step of or an actual physical aspect of the operation is recorded at the same time; wherein said at least one parameter is a plurality of parameters; wherein sensor apparatus is used to measure said at least one parameter; wherein said oilfield operation is a drilling operation; wherein said second data is generated by apparatus including at least one hand-held device; said presentation apparatus including display apparatus for displaying said first data and said second data; wherein said display apparatus includes at least one visually viewable screen and/or audio playback apparatus; wherein said at least one screen visually displays said first data and said second data as a function of time; wherein first data and second data for a particular time are presented together; wherein said at least one screen includes at least one screen of computer apparatus, and wherein a display on said at least one screen of computer apparatus includes at least one icon for said second data and the system has icon apparatus for selecting said at least one icon to view on said at least one screen of computer apparatus an image of said actual physical aspect of said oilfield operation related to said second data; wherein said at least one icon is a plurality of icons, each icon corresponding to an image related to said second data; wherein said display includes a display of a drilling log, said oilfield operation is a drilling operation, said at least one parameter is a parameter of the oilfield drilling operation, and the second data is related to at least one actual physical aspect of said oilfield drilling operation; wherein said display apparatus includes strip chart apparatus; said presentation apparatus including sound apparatus for presenting an audio playback related to said second data; server apparatus for receiving and storing said first data and/or sadi second data; network apparatus for receiving said first data and for transferring said first data; and/or said network apparatus for receiving said second data and for transferring said second data.

The present invention, therefore, in at least certain, if not all, embodiments, provides a method for acquiring data associated with an industrial operation, the method including acquiring with a system data related to the industrial operation, said system comprising first generating apparatus for generating first data representative of at least one parameter of an industrial operation, said first data generatable in digitized form, second generating apparatus for generating second data related to at least one image of an actual physical aspect of the industrial operation, said second data generatable in digitized form, storage apparatus for storing said first data and said second data, and presentation apparatus for simlutaneously presenting said first data and said second data.

The present invention, therefore, in at least certain, if not all, embodiments, provides a method for acquiring data associated with an oilfield operation, the method including acquiring with a system data related to the oilfield operation, said system comprising first generating apparatus for generating first data representative of at least one parameter of an oilfield operation, said first data generatable in digitized form, second generating apparatus for generating second data related to at least one image of an actual physical aspect of the oilfield operation, said second data generatable in digitized form, storage apparatus for storing said first data and said second data, presentation apparatus for simlutaneously presenting said first data and said second data. Such a method may have one or some, in any possible combination, of the following: wherein the presentation apparatus includes display apparatus and the method further including simultaneously displaying with display apparatus said first data and said second data; wherein said first data and said second data are displayed on a screen, wherein wherein said screen is a screen of computer apparatus, and wherein a display on said screen includes at least one icon for said second data and the system further comprising icon apparatus for selecting said at least one icon to view an image related to said second data, the method further including selecting said at least one icon, and viewing said image related to said second data; and/or wherein said presentation apparatus includes sound apparatus for presenting an audio image related to said second data, the method further including reproducing as audio said audio image.

The present invention, therefore, in at least certain, if not all, embodiments, provides a method of monitoring drilling parameters in real time, which includes the computer implemented steps of: displaying a list of drilling parameters for a drilling operation; displaying a graphical representation of each parameter of said set of drilling parameters; and simultaneously displaying a physically sensible image related to an actual physical aspect of a drilling operation. Such a method may have one or some, in any possible combination, of the following: wherein said display includes displaying an icon associated with said physically sensible image; wherein said physically sensible image is physically sensible via display apparatus that displays said drilling parameters; and/or wherein said graphical representation of said list of drilling parameters is displayed in response to user selection from said list.

The present invention, therefore, in at least certain, if not all, embodiments, provides a method of monitoring drilling parameters in real time, which includes the computer implemented step of: prompting a user to select a display screen from a list including a pre-developed screen choice, a custom screen choise, and a standard screen choice, wherein each of said screens is adapted to display simultaneous real time graphical representations of a set of drilling parameters, and viewing on at least one of said screens a physically sensible image related to an actual physical aspect of a drilling operation with which said drilling parameters are associated.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention. It is intended that each element or step recited in the following claims is to be understood as referring to all equivalent elements or steps and the claims are intended to cover the invention as broadly as legally possible in whatever form it may be utilized. The invention claimed herein is new and novel in accordance with 35 U.S.C. §102 and satisfies the conditions for patentability in §102. The invention claimed herein is not obvious in accordance with 35 U.S.C. §103 and satisfies the conditions for patentability in §103. This specification and the claims that follow are in accordance with all of the requirements of 35 U.S.C. §112. The inventors may rely on the Doctrine of Equivalents to determine and assess the scope of their invention and of the claims regarding apparatus not materially departing from, but outside of, the literal scope of the invention in the following claims.

1. A system for acquiring information associated with an industrial operation, the system comprising
first generating apparatus for generating first data representative of at least one parameter of an industrial operation, said first data generatable in digitized form,
second generating apparatus for generating second data related to at least one image of an actual physical aspect of the industrial operation, said second data generatable in digitized form,
storage apparatus for storing said first data and said second data, and
accessing apparatus for simlutaneously accessing said first data and said second data.

2. A system for acquiring information associated with oilfield operations, the system comprising
first generating apparatus for generating first data representative of at least one parameter of an oilfield operation, said first data generatable in digitized form,
second generating apparatus for generating second data related to at least one image of an actual physical aspect of the oilfield operation, said second data generatable in digitized form,
storage apparatus for storing said first data and said second data, and
presentation apparatus for simlutaneously presenting said first data and said second data.

3. The system of claim 2 wherein said at least one image is from the group consisting of recorded audio images and recorded visual images of said actual physical aspect of said oilfield operation.

4. The system of claim 3 wherein said second data relates to an audio image of said actual physical aspect of said oilfield operation recorded by sound recording apparatus.

5. The system of claim 3 wherein said second data relates to a visual image of said actual physical aspect of said oilfield operation recorded by a photographic camera.

6. The system of claim 3 wherein said second data relates to visual images of said aspect of said oilfield operation recorded by video camera apparatus.

7. The system of claim 2 wherein said first data and said second data are generated simultaneously.

8. The system of claim 2 wherein said at least one parameter is a plurality of parameters.

9. The system of claim 2 wherein sensor apparatus is used to measure said at least one parameter.

10. The system of claim 2 wherein said oilfield operation is a drilling operation.

11. The system of claim 2 wherein said second data is generated by apparatus including at least one hand-held device.

12. The system of claim 2 further comprising
said presentation apparatus including display apparatus for displaying said first data and said second data.

13. The system of claim 12 wherein said display apparatus includes at least one screen.

14. The system of claim 13 wherein said at least one screen visually displays said first data and said second data as a function of time.

15. The system of claim 14 wherein first data and second data for a particular time are presented together.

16. The system of claim 13 wherein said at least one screen includes at least one screen of computer apparatus, and wherein a display on said at least one screen of computer apparatus includes at least one icon for said second data and the system further comprising
icon apparatus for selecting said at least one icon to view on said at least one screen of computer apparatus an image of said actual physical aspect of said oilfield operation related to said second data.

17. The system of claim 16 wherein said at least one icon is a plurality of icons, each icon corresponding to an image related to said second data.

18. The system of claim 17 wherein said display includes a display of a drilling log, said oilfield operation is a drilling operation, said at least one parameter is a parameter of the oilfield drilling operation, and the second data is related to at least one actual physical aspect of said oilfield drilling operation.

19. The system of claim 12 wherein said display apparatus includes strip chart apparatus.

20. The system of claim 2 further comprising
said presentation apparatus including sound apparatus for presenting an audio playback related to said second data.

21. The system of claim 2 further comprising
server apparatus for receiving and storing said first data.

22. The system of claim 2 further comprising
server apparatus for receiving and storing said second data.

23. The system of claim 2 further comprising
network apparatus for receiving said first data and for transferring said first data.

24. The system of claim 23 further comprising
said network apparatus for receiving said second data and for transferring said second data.

25. A method for acquiring data associated with an industrial operation, the method comprising
acquiring with a system data related to the industrial operation, said system comprising first generating apparatus for generating first data representative of at least one parameter of an industrial operation, said first data generatable in digitized form, second generating apparatus for generating second data related to at least one image of an actual physical aspect of the industrial operation, said second data generatable in digitized form, storage apparatus for storing said first data and said second data, and accessing apparatus for simlutaneously accessing said first data and said second data .

26. A method for acquiring data associated with an oilfield operation, the method comprising
acquiring with a system data related to the oilfield operation, said system comprising first generating apparatus for generating first data representative of at least one parameter of an oilfield operation, said first data generatable in digitized form, second generating apparatus for generating second data related to at least one image of an actual physical aspect of the oilfield operation, said second data generatable in digitized form, storage apparatus for storing said first data and said second data, presentation apparatus for simlutaneously presenting said first data and said second data .

27. The method of claim 26 wherein the presentation apparatus includes display apparatus and the method further comprising
simultaneously displaying with display apparatus said first data and said second data.

28. The method of claim 26 wherein said first data and said second data are displayed on a screen, wherein wherein said screen is a screen of computer apparatus, and wherein a display on said screen includes at least one icon for said second data and the system further comprising icon apparatus for selecting said at least one icon to view an image related to said second data, the method further comprising
selecting said at least one icon, and
viewing said image related to said second data.

29. The method of claim 26 wherein said presentation apparatus includes sound apparatus for presenting an audio image related to said second data, the method further comprising
reproducing as audio said audio image.

30. A method of monitoring drilling parameters in real time, which comprises the computer implemented steps of:
displaying a list of drilling parameters for a drilling operation;
displaying a graphical representation of each parameter of said set of drilling parameters; and
simultaneously displaying a physically sensible image related to an actual physical aspect of a drilling operation.

31. The method of claim 30 wherein said display includes displaying an icon associated with said physically sensible image.

32. The method of claim 30 wherein said physically sensible image is physically sensible via display apparatus that displays said drilling parameters.

33. The method of claim 30 wherein said graphical representation of said list of drilling parameters is displayed in response to user selection from said list.

34. A method of monitoring drilling parameters in real time, which comprises the computer implemented step of:
prompting a user to select a display screen from a list including a pre-developed screen choice, a custom screen choise, and a standard screen choice, wherein each of said screens is adapted to display simultaneous real time graphical representations of a set of drilling parameters, and
viewing on at least one of said screens a physically sensible image related to an actual physical aspect of a drilling operation with which said drilling parameters are associated.

35. Any invention disclosed herein.
